(19) United States
(12) Patent Application Publication
(10) Pub. No.: US 2013/0262564 A1
(43) Pub. Date: Oct. 3, 2013

(54) INTERACTIVE MEDIA DISTRIBUTION SYSTEMS AND METHODS

(71) Applicant: IMMEDIATE, LLC, Kingston, NJ (US)

(72) Inventors: Robert Emmet Christopher Wall, Kingston, NJ (US); Vernon Alexander Hamilton, Jersey City, NJ (US); Stephan Alexander Katsivelos, New York, NY (US); David James Barker, Jersey City, NJ (US); Adam Craig Reinhardt, New Providence, NJ (US)

(73) Assignee: Immediate, LLC, Kingston, NJ (US)

(21) Appl. No.: 13/674,002

(22) Filed: Nov. 10, 2012

Related U.S. Application Data
(60) Provisional application No. 61/618,720, filed on Mar. 31, 2012.

(51) Int. Cl. G06F 15/16

(52) U.S. Cl. 709/203

(57) ABSTRACT

An interactive media commenting system includes a client computing system, a server communicatively coupled to the client computing system, a media server coupled to the client computing system and an interactive media module residing on the client computing system and configured to record and playback and interactive comment coupled to a webpage provided by the server.

### CROSS REFERENCE TO RELATED APPLICATIONS

This application claims the benefits of the legally related U.S. Provisional Patent Application Ser. No. 61/618,720 filed Mar. 31, 2012, which is fully incorporated herein by reference.

### BACKGROUND

The present invention relates to online media, and more specifically, to systems, methods and computer program products for providing video and audio commentaries for online advertisements, product reviews, and publishing platforms.

Currently, many websites that offer products include reviews via text comments. In addition, other websites that offer any kind of commentary are often also text format. Where there is audio/video commentary, an upload of the audio/video commentary is required. Currently, text commentary is limited and uploading of audio/video commentary requires a user to go through additional uploading/downloading steps to provide audio/video commentary.

### SUMMARY

Exemplary embodiments include an interactive video commenting system, including a client computing system, an advertisement server communicatively coupled to the client computing system, a media server coupled to the client computing system and an interactive media module residing on the client computing system and configured to record and playback and interactive comment coupled to an online advertisement provided by the advertisement server.

Additional exemplary embodiments include an interactive video commenting method, including receiving a web page in a computing system memory, receiving an electronic advertisement in the computing system memory, the electronic advertisement being embedded in the web page and uploading a video clip into the electronic advertisement, the video clip being a comment related to the electronic advertisement.

Additional exemplary embodiments include a computer program product including a non-transitory computer readable medium storing instructions for causing a computer to implement an interactive video commenting method. The method includes receiving a web page in a computing system memory, receiving an electronic advertisement in the computing system memory, the electronic advertisement being embedded in the web page and uploading a video clip into the electronic advertisement, the video clip being a comment related to the electronic advertisement.

Additional exemplary embodiments include an interactive media commenting system, including a client computing system, a server communicatively coupled to the client computing system, a media server coupled to the client computing system and an interactive media module residing on the client computing system and configured to record and playback and interactive comment coupled to webpage provided by the server.

Additional exemplary embodiments include an interactive media commenting method, including receiving a web page in a computing system memory, receiving an electronic forum in the computing system memory, the electronic forum being embedded in the web page and uploading a media clip into the electronic forum, the media clip being a comment related to the electronic forum.

Further exemplary embodiments include an electronic card generation method, including generating a webpage having an interactive media greeting card, generating a plurality of participant greetings within the interactive media greeting card and sending the interactive media greeting card to a recipient.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1A illustrates an exemplary interactive multi-media distribution system;

FIG. 1B illustrates an exemplary user-generated interactive advertisement commenting system from a backend technology perspective;

FIG. 2 illustrates a flowchart of an interactive advertisement commenting method in accordance with exemplary embodiments;

FIG. 3 illustrates a screen shot of an exemplary interactive media interface in accordance with exemplary embodiments;

FIG. 4 illustrates a screen shot of a login/create account interface in accordance with exemplary embodiments;

FIG. 5 illustrates a screen shot of an exemplary authorization interface 500 having a conventional authorization box;

FIG. 6 illustrates a screen shot of a audio/video interface in which the user can preview their live camera image and audio as well as depress the record button to record the video clip;

FIG. 7 illustrates a screen shot of an exemplary interface presented to the user upon depressing a recording button;

FIG. 8 illustrates a screen shot of an options interface in accordance with exemplary embodiments;

FIG. 9 illustrates a screen shot of an interface similar to the interface of FIG. 6, in which the recently recorded video clip is placed in a thumbnail awaiting review and approval;

FIG. 10 illustrates an interface schematically illustrating the recently recorded and approved video clip ready to be played back in accordance with exemplary embodiments; and placed at the end of the video comment thread;

FIG. 11 illustrates a screen shot of an exemplary approval screen;

FIG. 12 illustrates a schematic of an exemplary approval interface;

FIG. 13 illustrates a flowchart for a interactive media greeting card method in accordance with exemplary embodiments;

FIG. 14A illustrates an example of a host (i.e., initiator) workflow for an interactive media greeting card in accordance with exemplary embodiments;

FIG. 14B illustrates an example of a participant and initiator follow-up workflow in accordance with exemplary embodiments;

FIG. 14C illustrates an example of a recipient workflow in accordance with exemplary embodiments;

FIG. 14D illustrates an example of an exemplary interactive media greeting card; and

FIG. 15 illustrates an exemplary embodiment of a computing system that can be implemented for the interactive advertisement commenting methods described herein.

### DETAILED DESCRIPTION

In exemplary embodiments, a media distribution system and method implement a low bandwidth video recorder and video player that is embedded in a variety of network based applications for a global system of interconnected computer networks (e.g., the Internet). For example, the systems and methods described herein is a software application that can be embedded in any website to provide a video commentary system. The systems and methods described herein provide personalized video presentation that can be shared on any global computing network. The systems and methods described herein allow a user to record directly into a module on any website that does require any upload or download of audio/video clips. For example, the systems and methods described herein provide an application that is built directly into any webpage, allowing a user to use his/her local webcam or audio video recorder to record the audio video clips, thereby allowing the audio/video clips to be recorded directly into the webpage. The software application resides on media servers and can be licensed to clients to host on other servers. Front end displays whether on review modules, interactive media greeting cards or interactive advertisements, or other interactive media webpages, all described further herein are served from a common media server. In exemplary embodiments, the software is initially provided into a given website via embeddable iframe code, for example. As such, during runtime, there is no additional software to download. All content is viewed and curated via various stylized pages served by media servers. As such, in any webpage in which text comments can be provided, the systems and methods described herein provide a video commentary application that replace or complement text comments. It will be appreciated that any suitable computing device such as but not limited to a desktop and laptop computer, or any portable electronic device can support the systems and methods described herein. As such, the video distribution systems and methods described herein enables recording of a video/audio clip at any particular location having the configuration to record the video/audio clip. The video distribution applications described herein can be embedded into and/or associated with any electronic advertisement, for example. The systems and methods described herein can also reside on any mobile device. In exemplary embodiments, all of the interactive media features described herein can also be implemented on applications for mobile devices. In this way, at any given time or place, a user can record a video/audio clip and then have either predetermined locations or default locations to which the video/audio clip can be pushed. For example, the user may be at a professional sports game. During a play, the user can opt to record a video/audio clip commenting on a particular play. The video/audio clip can then be pushed to the professional sport website and associated with the game at a time associated with the play in which the user commented. In addition, predetermined sponsors can advertise their products and services at predetermined times during the game. The sponsor can then invite users to record their video/audio clips related to the advertised goods and services. Any recorded video/audio clips can then be associated with the particular time and place of the good or service in which the sponsor invited the video/audio clips. In exemplary embodiments, the video distribution systems and methods described herein on any device (e.g., a mobile device) can also include a barcode reader so that the device can read the barcode reader to be directed to a website of interest. At the time of redirection, the user can then record his/her video/audio clip.

In exemplary embodiments, the systems and methods described herein receive and process video images for webpages via the video recorder and video player. The systems and methods described herein also provide a real time in-webpage video capturing capability thereby allowing a webpage visitor to contribute to the webpage. For example, the systems and methods described herein enable a webpage advertiser to solicit video input from a webpage consumer. In this way, the consumer can provide an audio and video clip that is captured into the module, thereby allowing interactive advertising on the webpage. Subsequent webpage users can further comment on existing audio/video clips in addition to adding new audio/video clips. The advertisements described herein can be any sort of electronic advertisement (e.g., 300 pixels×250 pixels, expandable/collapsible and takeover ads, etc.)

In further exemplary embodiments, advertisement providers can provide a video recorder and player that records in real time, capturing the recordings to a remote server (e.g., via a cloud). As such, the webpage user generated content is not saved locally to the webpage user's computing device, but rather a live stream is captured on the remote server, then upon approval embedded within the online product. It will be appreciated that although the generated content is saved on a remote server, the generated content can also be saved locally. In exemplary embodiments, the clip length can be limited to a specified duration (e.g., 15 seconds, although unlimited periods are also contemplated). Furthermore, the size of the video clip that is embedded into the online product can also be limited to a particular size. For example, the clip can be limited to a 133 pixel by 76-pixel thumbnail. It can be appreciated that publishers associated with the online product can then choose selected videos that positively reflect the product so that the selected content pertains positively to the specific product or service associated with the online product.

In exemplary embodiments, a default state of the loaded advertisement can feature a playback queue in chronologically time-stamped order of the selected recordings for other users to view. By recording directly to the (cloud) servers, the webpage user need not upload anything because their video is captured in real time to a remote server. After the webpage user records and submits their video, the webpage user is directed back to the default playback queue, at the same point in the playlist before the webpage user initiated their own recording. Once the webpage user's video clip is approved, the video clip is loaded into the playlist within the online advertisement.

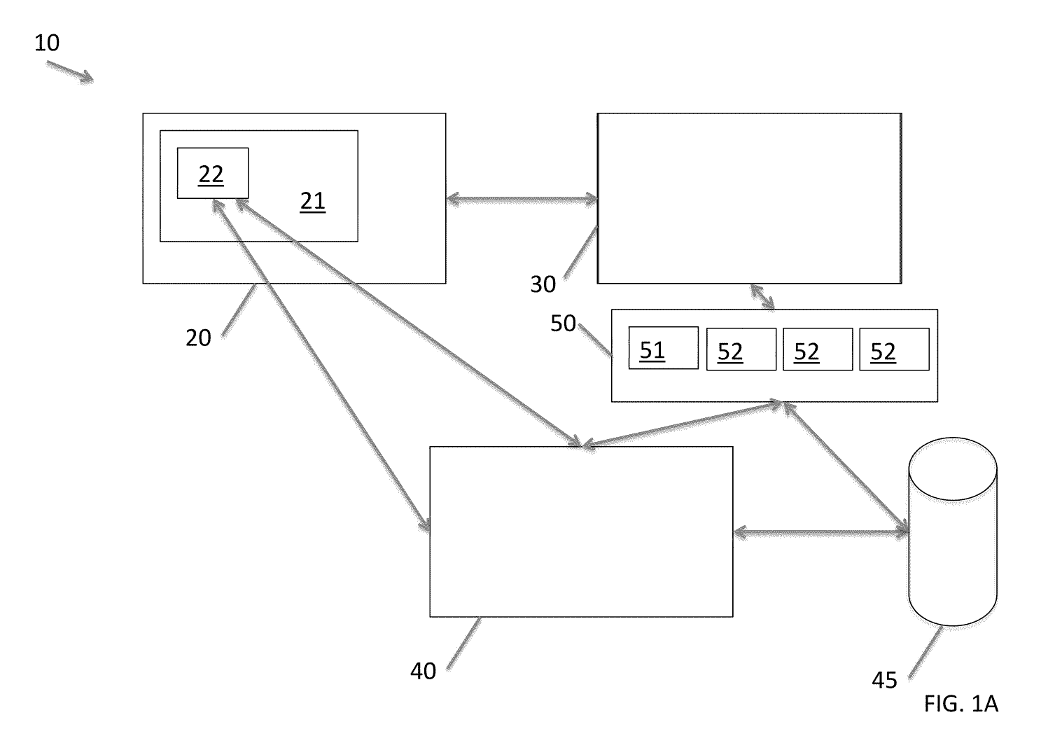

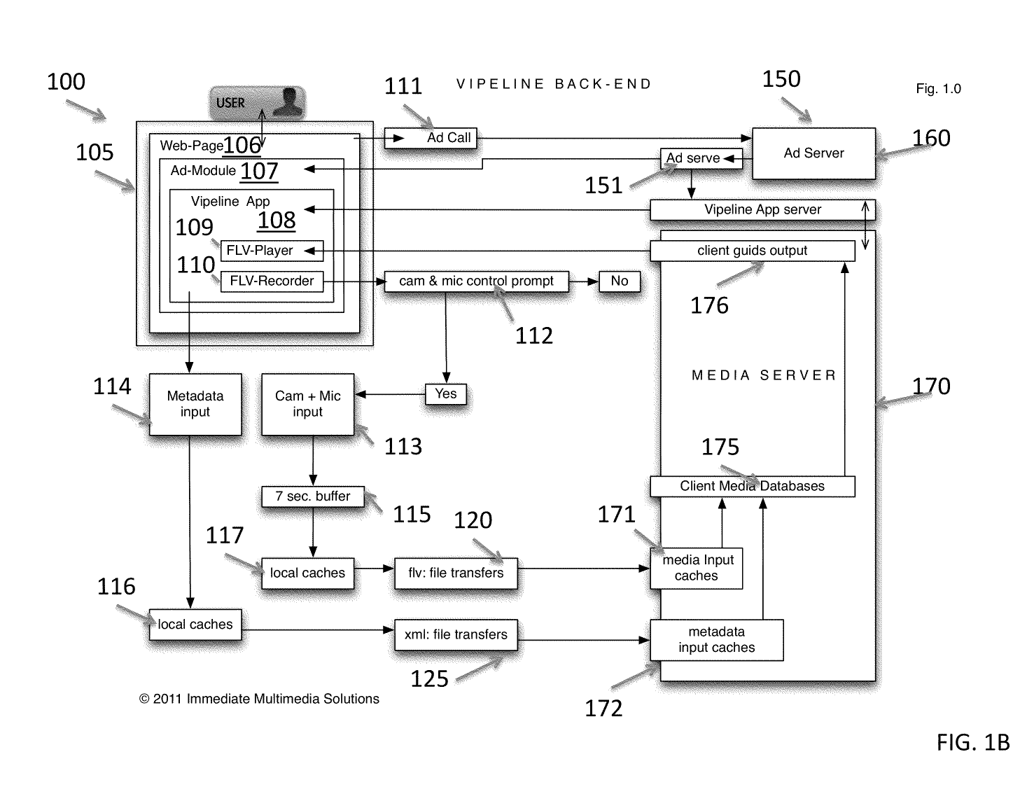

FIG. 1A illustrates an exemplary interactive multi-media distribution system 10. In exemplary embodiments, the system 10 includes a client machine 20 in which a webpage 21 can be loaded as known in the art. The webpage 21 can be provided by any server 30 providing any sort of webpage known in the art. The client machine 20 can also include an exemplary interactive multi-media application 22 (e.g., non-downloadable software which allows the user to record, playback, review and share audio and video clips on various websites). The interactive multi-media application 22 is provided by a media server 40, which can include an audio/video clip storage medium 45. In exemplary embodiments, the user of the client machine can record any audio/video clip 50 via the interactive multi-media application 22 to provide any sort of audio/video commentary related to the webpage 21. In exemplary embodiments, the audio/video clip 50 can be stored in a file 51 in any multi-media file format such as but not limited to flash video (FLV). In addition, the file 51 can have multiple individual clips 52 (thumbnails) as described further herein. The commentary can be stored locally on the client machine, and/or can be stored on the server 30 providing the webpage 21, and or can be stored in a master database in the audio/video clip storage medium 45. As further described herein, the master database can include all audio/video clips recorded on any client machine or website. In exemplary embodiments, the master database can also include speech to text translations of the audio/video clips. A user can also have access to any audio/video clip that particular user ever recorded on any website via the master database. It will be appreciated that the storage medium is available for any user to search for any audio/video clip for any particular piece of subject matter for which the audio/video clip was recorded.

It will be appreciated that the webpage 21 and associated website (and web provider of the server 30) can be related to any subject matter upon which commentary can be attached. For illustrative purposes, an interactive product commenting system is described with respect to FIG. 1B herein. However, it will be appreciated that in other exemplary embodiments, the system 10 can be applied to other types of systems.

For example, other systems can include but are not limited to a live (online) or offline audio/video clip forum in which a moderator is presented live via a computer or television screen and receives questions via the exemplary video distribution system. In exemplary embodiments, the online/offline forum can enable students, for example, to interact with a professor in an online/offline course. For example, the video distribution system can be part of a website in which a professor lectures via a website. The students in the global audience can record video/audio clips via the interactive multi-media application 22 on their respective machine, and submit their audio/video clips to the server from which the professor is lecturing. The professor can then view the audio/video clip and respond via the respective website. Similarly, a website can exist that caters to medical issues. Users can submit video/audio clips asking medical questions to which qualified medical professionals can respond.

In another example, the media distribution systems described herein can be implemented on a television or live stream as a scan converted overlayed graphic (e.g., a lower third graphic). The live streaming can be accompanied by a module on the particular show's website, or as a page upon which the live stream is embedded. In other exemplary embodiments, a record application can be triggered by a remote control engaging an application via smart TV or set top box. In exemplary embodiments, users respond to show content or participate in a question and answer session via the application. In exemplary embodiments, the live module appears as a lower third graphic on the screen—upon vetting and approval the show host can play back video/audio clips in the application as desired. In exemplary embodiments, users see their video/audio clips pop up on the screen when they have been approved for air. In exemplary embodiments, the systems and methods described herein, insert the series of video/audio clips into a live stream as a scan conversion of a web page with a series of video/audio clips at the very top of the page with a bottom-up wipe of that page that reveals only as a lower third.

In other exemplary embodiments, the media distribution systems and methods described herein can implement a webpage in which differing opinions can be presented as video/audio clips. For example, in exemplary embodiments, a left and right side of a video screen can be set up as differing political opinions into which video/audio clips can be inserted expressing the differing political opinions. A moderator can provide questions and issues to which users can provide comments. As such, in exemplary embodiments, a web page can be set up in which a user can include video/audio clips (i.e., positive comments or reviews) and on the other opinions (i.e., where multiple users can complain about various topics).

In other exemplary embodiments, the media distribution systems and methods described herein can implement electronic mail (email) web pages on a network (which can be extended to internet protocol television) and mobile. As such, electronic mail can be implemented as video/audio clips onto which attachments can be made. In other exemplary embodiments, conventional email can be replaced by audio/video clips in which the audio/video clip replaces traditional text. Any attachments normally attached to an email can be attached to the audio/video clip.

In other exemplary embodiments, the media distribution systems and methods described herein can implement video distributions systems and methods for dating and match-finding implementations. As such, a user can implement video/audio clips for exchanging communications among users for purposes of finding a mate.

In other exemplary embodiments, the video distribution systems and methods described herein can be offered on any player or console that offers an application for cable set top boxes. As such, a suite of video/audio applications can be offered for full functionality of video distribution systems. In this way, any built-in cams (i.e., X-box or Wii cams) can be implemented.

In any of the implementations described herein, the client camera/recorder that records the audio/video clip takes a finite amount of time to ready itself. In exemplary embodiments, the systems and methods described herein can provide an advertisement that plays via the interactive multi-media application 22, but provided by another third party advertiser. In this way, the user views an advertisement instead of viewing dead air while waiting for the camera/recorder to ready itself.

Conventionally, when a video clip is recorded, a particular thumbnail is presented that represents the recording. In exemplary embodiments, the systems and methods described herein allow the user to select a thumbnail associated with the recorded audio/video clip. In exemplary embodiments, the audio/video clips described herein can be of a relatively short duration (e.g., 15 to 30 seconds although longer durations are contemplated). As such, every second of the video can be shown as a thumbnail, and before the user submits the audio/video clip, the user can review the audio/video clip and associated thumbnails and pick the thumbnail that the user wants to use as the representative thumbnail. In exemplary embodiments, the user can also customize the thumbnails in various ways. In exemplary embodiments, the entire audio/video clip can also be customized via the interactive multi-media application 22. As such, the user can select a custom background, embed text, change the lighting, add effects, and the like. It will be appreciated that the audio/video clip that is recorded includes an actual representation of the user that recorded the audio/video clip. In exemplary embodiments, in the customization process, the user can replace his/her actual representation with an avatar that represents the user. In this way, an animated character can represent the user in the audio/video clip, thereby allowing some anonymity and creativity for the user. In exemplary embodiments, the avatar is fully customizable to allow the user to have a wide range of choices from which to decide. In exemplary embodiments, famous character avatars can be purchased or the user can customize his/her avatar from available selections. In exemplary embodiments, the audio in the audio/video clip is matched up with the mouth moments and emotions of the avatar to give the impression that the avatar is actually speaking. The user can also alter the pitch of the audio portion. Within the avatar customization process, the user can choose real world accessories and products, for a cost, to equip the avatar. For example, the user can select professional sports team logos, Jerseys and hats or famous characters from video games.

FIG. 1B illustrates an exemplary interactive media distribution system 100. For illustrative purposes, an interactive product commenting system is described as the system 100. However, it will be appreciated that in other exemplary embodiments, the system 100 can be applied to other types of systems.

In exemplary embodiments, the system 100 includes a client computing device 105 that can be any suitable computing device such as but not limited to a desktop computer, laptop computer, personal computing device or any suitable mobile computing device. A webpage 106 can reside in any suitable browser on the computing device 105. The webpage 105 can include an online product module 107 that has embedded within it, an exemplary interactive media module 108. It will be appreciated that the interactive media module 108 is implemented to include an audio/video clip that can be associated with the online product. The exemplary interactive media module 108 can include a player 109 (e.g., a flash video player) and a recorder 110 (e.g., a flash video recorder). As further described herein, the recorder 110 can be implemented by a webpage user to record an audio/video clip that can be embedded with the online product. The video player 109 is then implemented to playback the audio/video clip when selected from within the online product.

In exemplary embodiments, the system 100 further includes an advertisement server 150 from which online advertisements are provided to the advertisement module 107 for the webpage 106. The advertisement module 107 can request an online advertisement via an advertisement call module 111, and in turn the advertisement server 150 can provide the advertisement module 150 via an advertisement serve module 151. It can be appreciated that the advertisement server 150 is maintained by any entity that provides online advertisements. In exemplary embodiments, the system 100 can further include an interactive media server 160 that provides the interactive media module 108 to the online advertisement module 107 and to which the recorded audio/video clips are captured to server upon recording. The interactive media server 160 is coupled to a media server 170 that interacts with the interactive media server 160 to manage the recorded audio/video clips.

In exemplary embodiments, if the webpage user records an audio/video clip, the webpage user can implement a cam and microphone local to the webpage user. The interactive media module 108 can generate a cam and microphone prompt 112 and receive cam and microphone input 113 via the recorder 110. The interactive media module 108 can further generate any associated metadata 114. The cam and microphone data 113 can be buffered in a buffer 115 (e.g., seven seconds). The cam and microphone data 113 can then be stored in a local cache 117. The metadata 114 can also be stored in a local cache 116. In exemplary embodiments, the metadata can be stored in any suitable format including but not limited to extensible markup language (XML). The cam and microphone data 113 can then be stored and transferred in any suitable file format 120. Similarly, the metadata 114 can be stored and transferred in any suitable file format 125.

The cam and microphone file format 120 is received in the media server 170 in a media input cache 171, and the metadata file format 125 is received in the media server 170 in a metadata input cache 172. It can be appreciated that the cam and microphone file format 120 and the metadata file format 125 make-up the audio video clip, which is then stored in client media databases 175 within the media server 170. The media server 170 can further include a series of client file identifiers 176 such as globally unique identifiers (GUID) that can be implemented to retrieve video clips from the databases 175 when the clips are called to be played back in the player 109.

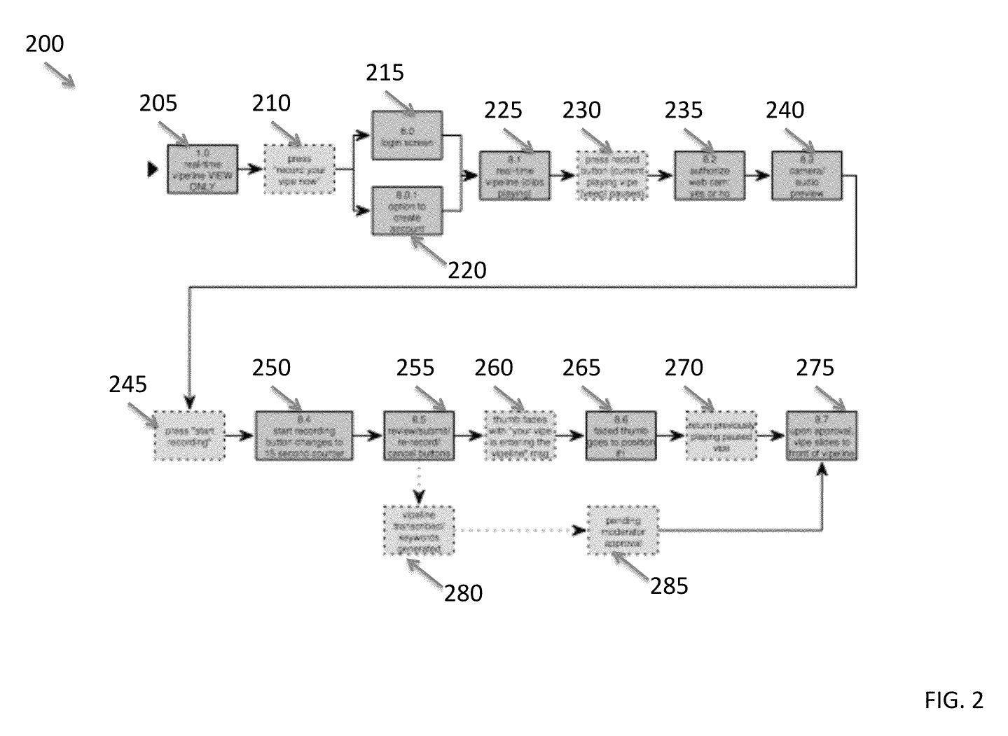

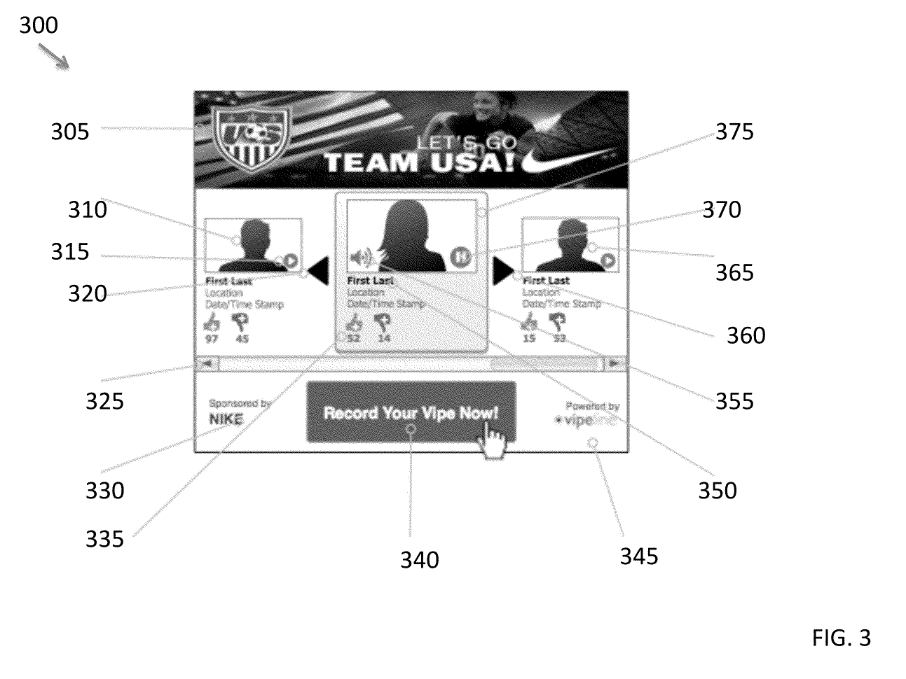

FIG. 2 illustrates a flowchart of an interactive video commenting method 200 in accordance with exemplary embodiments. At block 205, the interactive media module 108 presents an interactive media user interface to the user. FIG. 3 illustrates an exemplary interactive media interface 300 in accordance with exemplary embodiments. The interface 300 includes a sponsored branding 305 in which the user can click through to get to the sponsored website, “sponsored by” information 330 and “powered by” information 345. The interface 300 further includes an inactive thumbnail position “carousel” (i.e., a module frame) in which previously recorded video clips 310, 365 are stored and can be scrolled. For example, the module frame can be displayed as a 50% opacity representation hover state. If the user clicks on a thumbnail in the module frame, the selected thumbnail and respective video is loaded into the center of module frame.

Upon clicking the jpeg encoded thumbnail representation of a pre-recorded clip, the clip begins to play back an h.264-encoded file in a flash video container. The interactive media module 108 acts upon the selected file by progressively downloading or streaming it in a linear fashion. When the file is initially captured it is encoded as a flash video clip for example with a predetermined duration such as 15 seconds. When the selected file is done streaming, its representation returns to that of a static jpeg encoded thumbnail in a scrollable playlist.

The interface 300 further includes a playback button 315 for an inactive video clip in the module frame, a back button 320 for loading an previous inactive video clip into the center position of the module frame, a forward button 360 for loading a future inactive video clip into the center position of the module frame, and a scrolling control 325 to navigate past and future video clips in the module frame. In exemplary embodiments, when the center active video clip 375 is playing, other clips load via a sliding effect in sequences from left to right or right to left. When the center video clip 375 is paused, clips 310, 365 that are represented as thumbnails at either side of the center clip as well as the center video clip 375 are scrolled. On scrolling, the user is essentially browsing through the client media databases 175 of video clips represented by series of static thumbnail jpeg encoded images captured as the first recorded frame of each submitted/approved video clip. Scrolling is performed by clicking a left or right arrow icon on respective edges of the module frame (310 and 360).

The center video clip 375 includes a pause button 370 for pausing the center video clip 375, a sound control 355 for the center video clip 375 and a demographic information display 350 showing, for example, the user name, location and timestamp of when the center video clip 375 appeared. The interface 300 can further include a record button 340 that can prompt the user for a login/create state at block 210.

As described further herein upon mouse-click of this button the interactive media module 108 sends a request to access the player 109 and the recorder 110. The request appears as an overlay dialog box over the module (112). The user has the option to grant access or not by clicking “accept” or “cancel”. Upon acceptance the words on the red rectangular button change to “record now” as further described herein.

The active clip 375 can include feedback icons 335 (e.g., thumbs up/down). A tally can be kept of the number of positive and negative responses for all clips. Tracking tools calculate how many positive and negative responses the user has received for the particular clip and all clips associated with that user.

At block 215 the interactive media module 108 prompts the user with a login screen or prompts the user with an option to create an account screen at block 220.

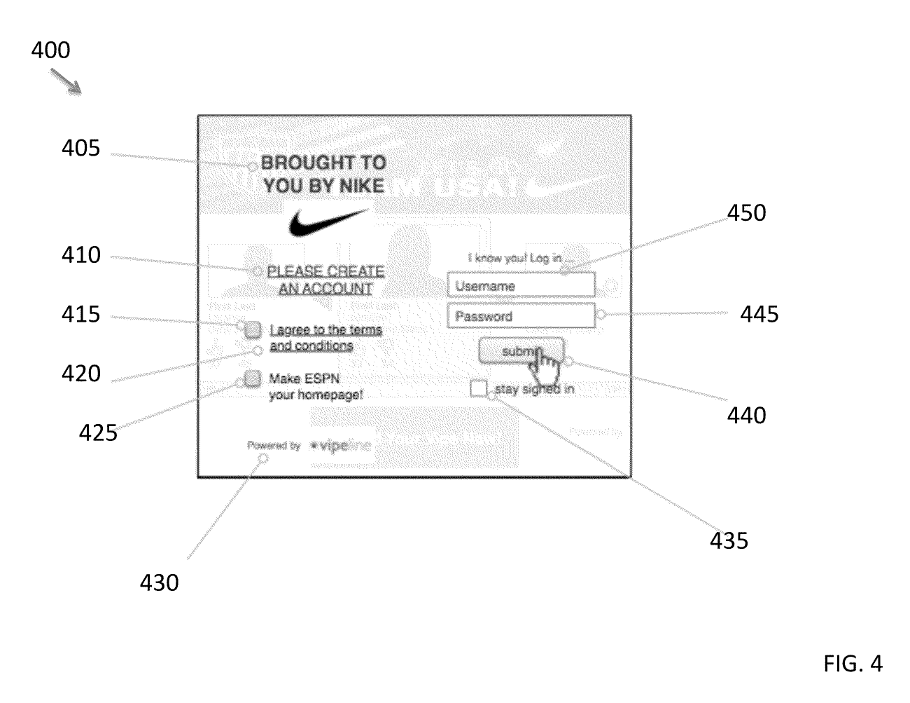

FIG. 4 illustrates a login/create account interface 400 in accordance with exemplary embodiments. The interface can include sponsored-by information 405 and powered-by information 430. The interface can further include an account creation control 410, an agreement field 415 to which the user agrees to the terms and conditions of use (which can be reached via a link 420), and a homepage option control 425. The interface 400 further includes a username fields 450, a password field 445 and a submit control 440 to submit the username and password. The interface 400 further includes a stay-signed-in control 435.

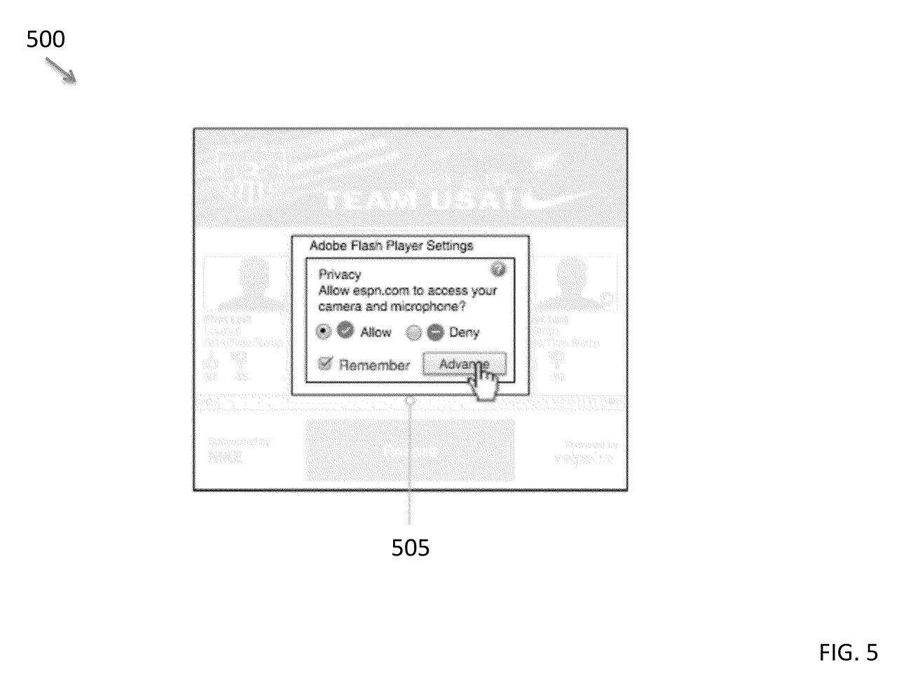

At block 225, the user is returned to the interface 300 of FIG. 3 and at block 230 can record the video clip by depressing the record button 340. At block 235, the interactive media module 108 prompts the user with a prompt inquiring whether the player 109 and the recorder 110 are authorized for recording the video clip. FIG. 5 illustrates an exemplary authorization interface 500 having a conventional authorization box 505.

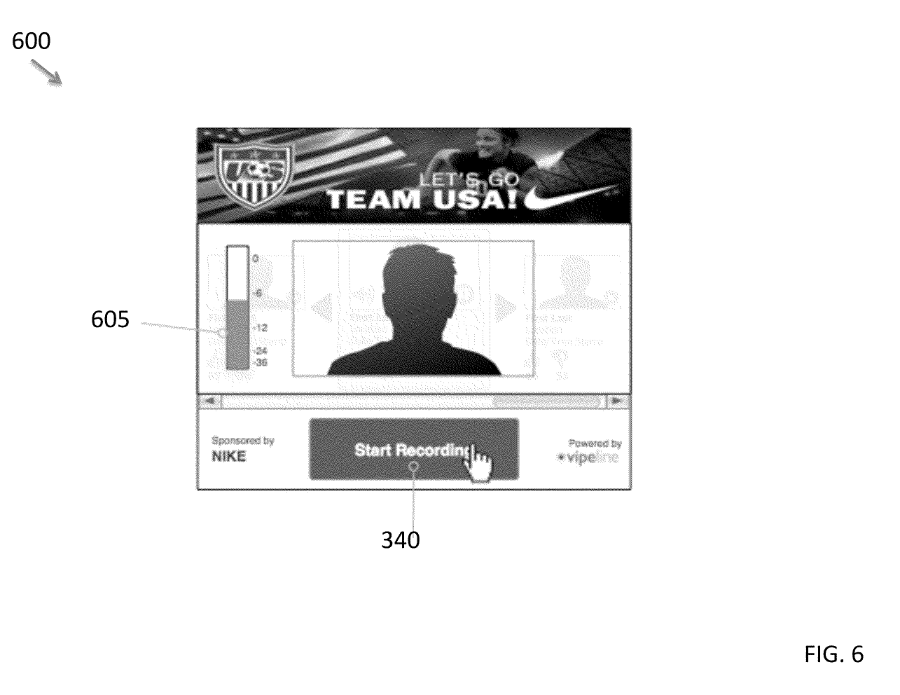

At block 240, the user can begin recording the video clip. FIG. 6 illustrates a audio/video interface 600 in which the user can depress the record button to record the video clip. The interface 600 further includes a volume meter 605 to ensure that the audio is being captured.

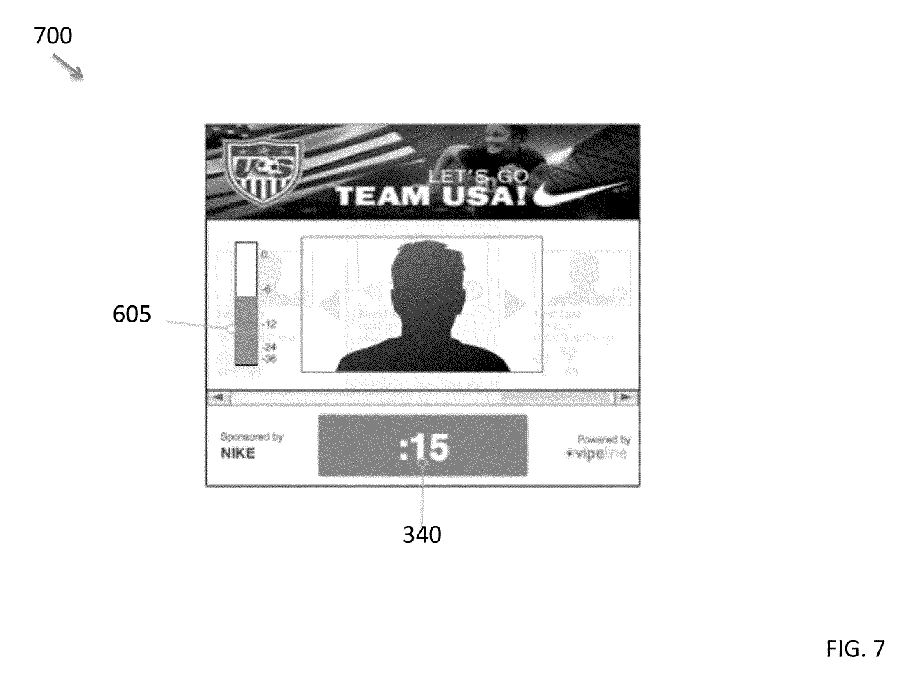

At block 245, the user depresses the record button 340 to begin recording the video clip. At block 250 the interactive media module 108 captures the video clip. In exemplary embodiments. Upon clicking the record button 340, the interactive media module 108 begins to capture and encode the users audio and video to a local cache 116 on client 105. Once the cache 116 on the client 105 has captured the predetermined amount of video (e.g., 15 seconds of audio and video), the interactive media module 108 begins to copy the encoded audio and video data to separate caches 171, 172 on the media server 170. In exemplary embodiments, the record button 340 changes appearance to a predetermined timer amount (e.g., 15 seconds) that begins to count down upon depressing the record button 340. FIG. 7 illustrates an exemplary interface 700 presented to the user upon depressing the recording button 340.

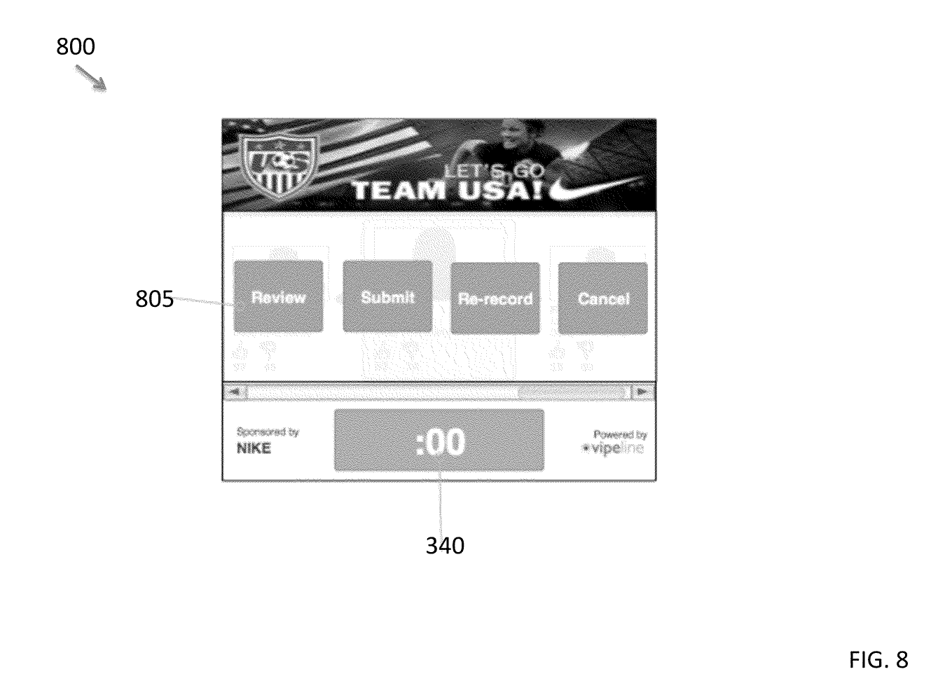

At block 255, after the video clip is recorded, the interactive media module 108 prompts the user with options related to the video clip. For example, the user can review, submit re-record or cancel the video clip. FIG. 8 illustrates an options interface 800 in accordance with exemplary embodiments. The interface 800 illustrates the record button 340 in a “grayed out” state and showing zero time left to record. The interface 800 further includes control options 805, such as to review, submit re-record or cancel the video clip as described herein. Upon selecting the option to review, the recording the user just made is played back from the local device (e.g., the player 109) even as the file is being copied over to the caches 171, 172 on the media server 170. Upon rejection of the recording the file replication is cancelled and the data in both the local cache 116 and the caches 171, 172 on the media server 170 is deleted. Upon selecting to accept and/or submit the recording, if the file has not completely replicated to the caches 171, 172 on the media server 170, the process continues. If the file has fully replicated and submission is selected, the cached file on the client 105 is deleted and the file on the media server 170 is moved into a different storage location and registered as an item in a database for pending review by the content curators.

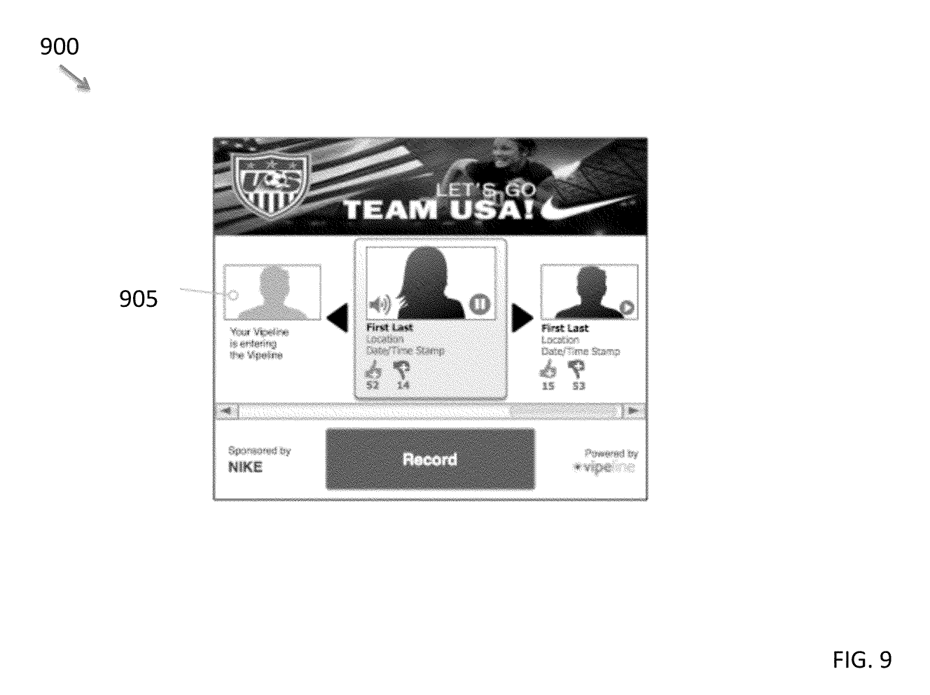

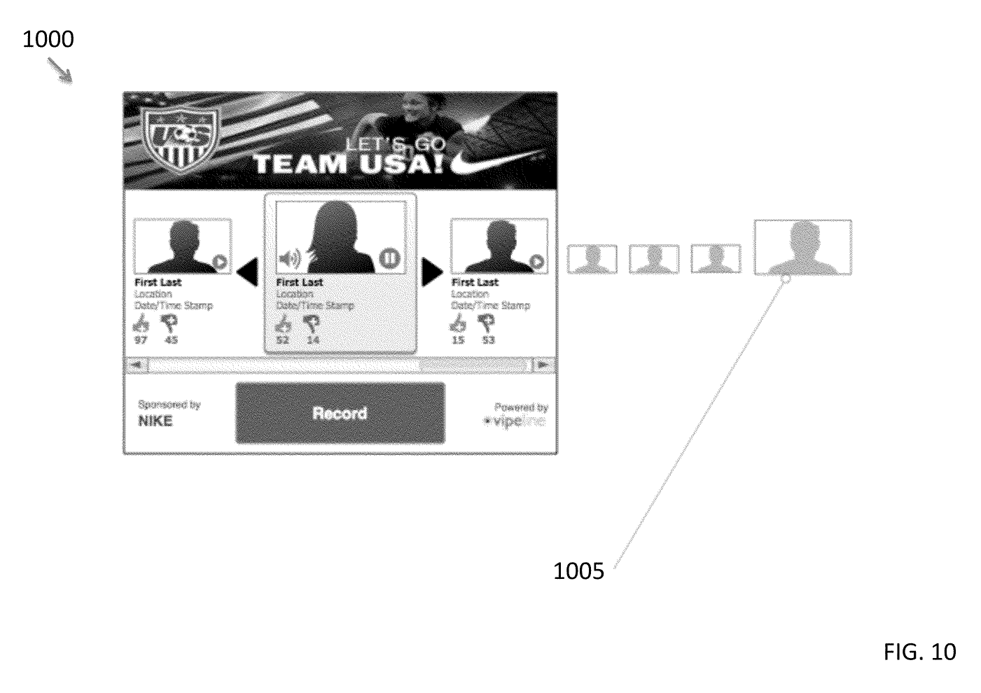

Once the user has accepted and submitted the recorded video clip, the clip fades into a thumbnail position off center. FIG. 9 illustrates an interface 900 similar to the interface 600 of FIG. 6, but in which the recently recorded video clip is placed in a thumbnail 905 awaiting review and approval. As such, at block 260, the thumbnail of the recently recorded video clip is placed in the module frame and at block 265 into a pending thumbnail position 905. In addition, at block 280, the video clip is transcribed and keywords are generated for transmission and storage in the client media databases 175 (see FIG. 1). At block 270, once the video clip is recorded, the interfaces described herein can return to a previously recorded and playing video clip such as the center video clip 375 of FIG. 3. At block 285, the recently recorded video clip pends approval. Upon approval, the recently recorded video clip is then placed in a most recent (far right, end of carousel playlist) position for future playback in the module frame. FIG. 10 illustrates an interface 100 schematically illustrating the recently recorded and approved video clip 1005 ready to be played back in accordance with exemplary embodiments.

At this point the video clip appears in the media server 170 content curation tool and a notification is sent via email to the moderator prompting them to engage the tool and accept or reject the clip. Upon selecting “accept” the file is moved to a separate “live” content database—represented as the scrollable area of the interface 300 within the ad. If the moderator selects “reject” the clip is deleted from the media server 170.

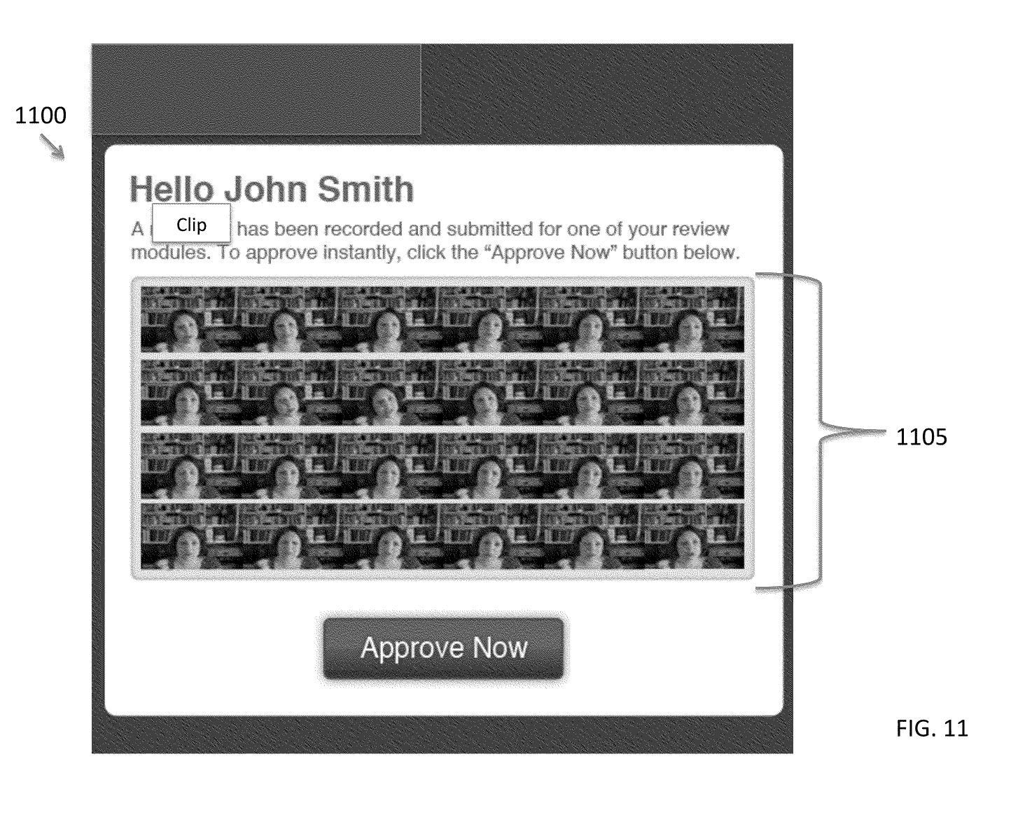

Referring again to FIG. 1A, interactive multi-media application 22 can be implemented to generate an audio/video clip 50 that can include multiple individual clips 52 from a multi-media file 51. Once the user records the audio/video clip 50 and is satisfied with the audio/video clip 50, including any customization and the like, the user can be prompted to submit the audio/video clip 50 for review before it is permitted to be posted. In exemplary embodiments, the interactive multi-media application 22 can include an approval screen that is displayed to the user, once the user is ready to submit the clip. FIG. 11 illustrates a screen shot of an exemplary approval screen 100. The screen 1100 can display the multiple thumbnails 1105 from which the user can select a representative thumbnail for the audio/video clip 50 as described herein. The screen 1100 can further include a button 1110 to submit the audio/video clip 50 for approval.

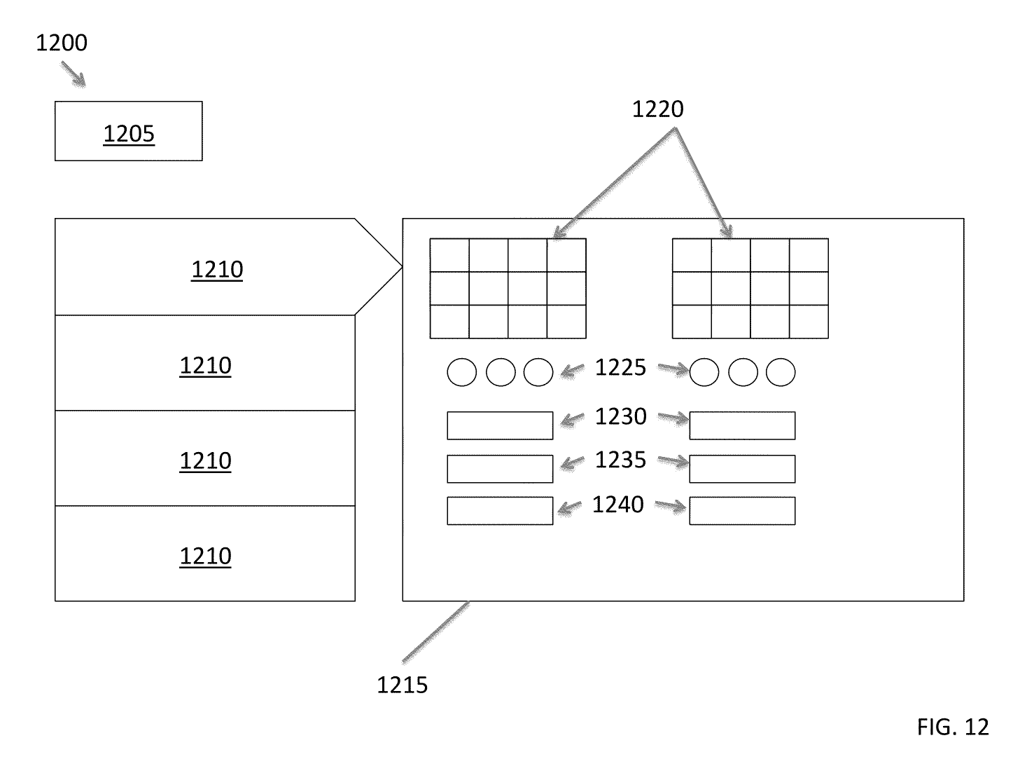

In exemplary embodiments, once the user submits the audio/video clip 50, the clip is then sent to a moderator for approval. The moderator can be associated with the media server 40 or the server 30 of the website provider. Regardless of the source of the moderator, the audio/video clip 50 is then reviewed for approval or rejection. In exemplary embodiments, the approval/rejection can be facilitated via an approval interface. FIG. 12 illustrates a schematic of an exemplary approval interface 1200. In exemplary embodiments, the approval interface 1200 is an all-in-one utility that allows site administrators to quickly sort through the multiple audio/video clips (e.g., the audio/video clip 50) that they want to use within their particular interactive multi-media module (e.g., interactive multi-media application 22).

In exemplary embodiments, the approval interface can include a create button 1205 that generates one or more review modules 1210. Each of the review modules represents a source of audio/video clips. For example, each review module may represent all the audio/video clips for a given website. As such, it can be appreciated that the moderator using the approval tool 1200 may be the moderator for multiple websites. Each review module 1210 therefore has multiple audio/video clips in a queue 1215 to review and approve or reject. For illustrative purposes, only two clips 1220 and associated review tools are shown. It will be appreciated that each review module 1210 can at anytime include tens hundreds or thousands of audio/video clips to review. As further described herein, each of the audio/video clips can be presented to the reviewer as multiple thumbnails, which can each represent a second of footage, for example, as described herein.

As such, the approval interface 1200 can be a frame-by-frame visual review system such that as each audio video clip 1220 is available for review, the administrator can quickly scan the individual frames or inspect the frames in more detail. For example, by hovering a mouse icon over the thumbnail image of the audio/video clip 1220, the administrator is able to view a grid of images for each second of the audio/video clip 1220. As such, if an audio/video clip 1220 is twenty nine seconds in length the review grid would display 29 frames for each second of the audio/video clip 1220. The approval interface therefore allows for administrators to quickly screen an entire audio/video clip 1220 without having to watch for the full duration. In this way any unwanted visuals can be quickly identified. In exemplary embodiments, the approval interface can also convert the audio of the audio/video clip 1220 into a text file which can be stored (e.g., in the storage medium 45 in FIG. 1A), and interfaced with the approval interface 1200. As such, any time an audio/video clip 1220 is recorded, a text file transcript is generated at the same time and is permanently associated with the corresponding audio/video clip 1220. In this way, any language that the administrator does not approve of in that particular audio/video clip 1220 can be identified. In addition, a database of key words for analytics to help with Internet searches regarding the subject matter contained within an audio/video clip 1220 can be maintained. The implementation of the text file transcript in conjunction with the thumbnails are described further herein.

In exemplary embodiments, the approval interface 1200 can further include a series of indicator lights 1225 for each audio/video clip 1220. For example, the indicator lights can be green yellow and red. A green light means that there are no unwanted words in the text file transcript, which can be automatically checked for each audio/video clip 1220. In addition, recognition software can be implemented to detect unwanted images (e.g., nudity). If no unwanted images are detected, and no unwanted words are detected, the green light can be illuminated. As such, the indicator lights 122 can indicate the status of the audio of the audio/video clip 1220 by screening the text file that it is attached to for unwanted words. A red light is an indication that unwanted words have been detected, and that possible unwanted images have been detected. A yellow light means that the system could not identify all of the audio in the audio/video clip 1220 and that it should be reviewed further to be approved. The green light tells the administrator that an audio/video clip 1220 audio is safe to use and has passed on all unwanted word and visual checks.

In exemplary embodiments, the approval interface 1200 can include an approve button 1230, which approves an audio/video clip 1220 and sends it through for presentation. The approval interface 1200 can further include a reject button 1235 that rejects an audio/video clip 1220 but maintains it for further review. The approval interface 1220 can further include a delete button 1240, which completely deletes the audio/video clip 1220 in response to unwanted words or images.

Several examples of interactive media distribution systems have been described herein. In other exemplary embodiments, an interactive media greeting card system and method are also contemplated. By implementing the interactive multi-media application 22 (of FIG. 1A), an interactive media greeting card can be generated. In exemplary embodiments, the interactive media greeting card system can include an audio/video player with recorder/review capabilities to display multiple videos simultaneously or individually. The interactive media greeting card system can include a group video message and individual messages. The interactive media greeting card system can also include an individual/group video recorded by a person/group, and/or a “celebrity” video previously recorded (stock video) by a person of celebrity (i.e., musician, politician, athlete, and the like). In exemplary embodiments, the interactive media greeting card can include one page or multi page “format” with various art work (personal or stock), text (personal or stock), and audio/video clips on each page or a selected page. As in previous exemplary embodiments, the interactive media recordings implement webcam and/or mobile devices to create/review/edit/view video messages, text, and artwork. In exemplary embodiments, sender/video participants may use a talking “avatar” for their videos recorded in the interactive media greeting card. In addition, the recipient/sender/video participants will be enabled to download a copy of the interactive media greeting card to a personal device. In exemplary embodiments, a recipient may create and edit/review a “response message” to sender/video participants by utilizing webcam and/or mobile device. The recipient may also use a talking avatar for the creation of the “response message”. In exemplary embodiments, as further described herein, the interactive media greeting card and the response message may be distributed via email, text messaging and social media.

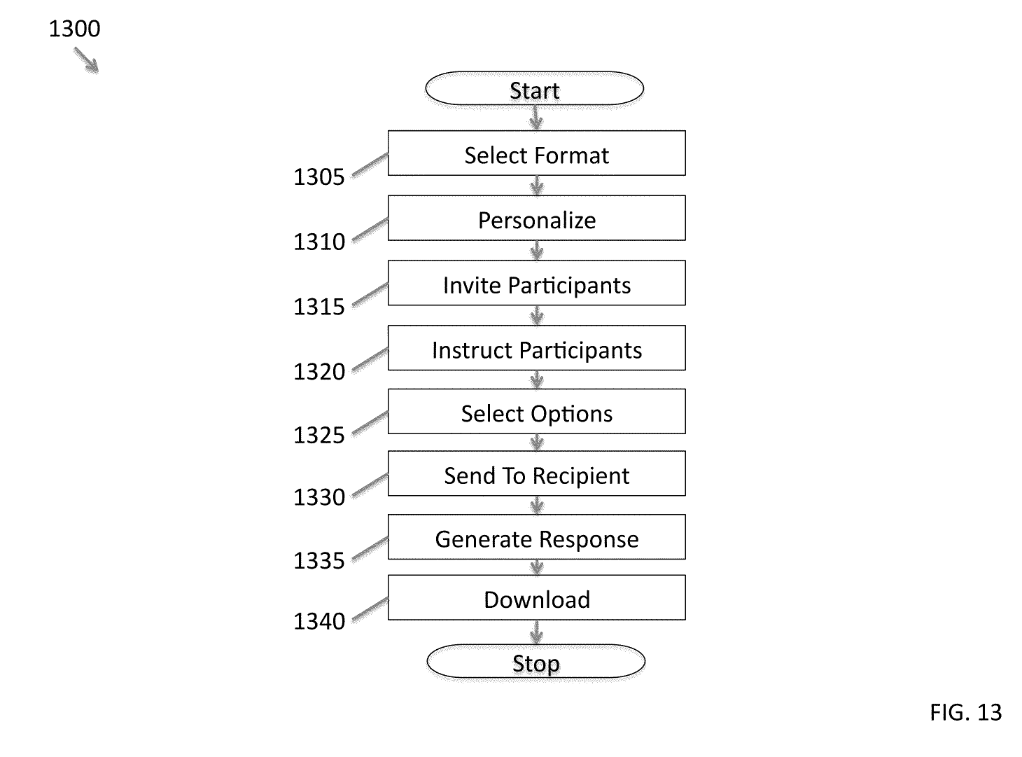

FIG. 13 illustrates a flowchart for a interactive media greeting card method 1300 in accordance with exemplary embodiments. At block 1305, the initiator of the interactive media greeting card selects a format for the interactive media greeting card based on desired artwork and desired audio/video clip arrangements (i.e. grid, flower arrangement, ledger format and the like). At block 1310, the initiator (or any participant) of the interactive media greeting card can add a personal note/artwork in the interactive media greeting card. At block 1315, the initiator of the interactive media greeting card invites participants to access the interactive media greeting card via a web-link that directs the user to a dedicated webpage that includes the selected interactive media greeting card format and instructions. It can be appreciated that the webpage can be made available to the user such as illustrated in FIG. 1. At block 1320, each participant (that can include the initiator) who has been invited by the initiator is prompted to follow recording directions. In exemplary embodiments, the instructions to the participants can include, but are not limited to: 1) Selecting a box (that can be a video player with recorder/review capabilities for that participant only); 2) choosing an avatar or their persona for the recording; 3) recording a “greeting” (i.e. Surprise, Happy Birthday, and the like, chosen by the Initiator); 4) reviewing the “greeting” and post; 5) prompting the user to record/review/post their personal comments in the same box. At block 1325, the initiator selects to include Recipient “Response” audio/video clip option and a “download to personal device” option. At block 1330, the interactive media greeting card is distributed to the recipient via, such as but not limited to, email, text, and social media. At block 1335, the recipient may view the card and elect to record a personal response and email, text, and/or distribute via social media. It can be appreciated that the recipient can implement an interactive multi-media application 22 (e.g., the interactive multi-media application 22 of FIG. 1A) to generate a response. At block 1340, all participants of the interactive media greeting card can download the interactive media greeting card to their personal devices.

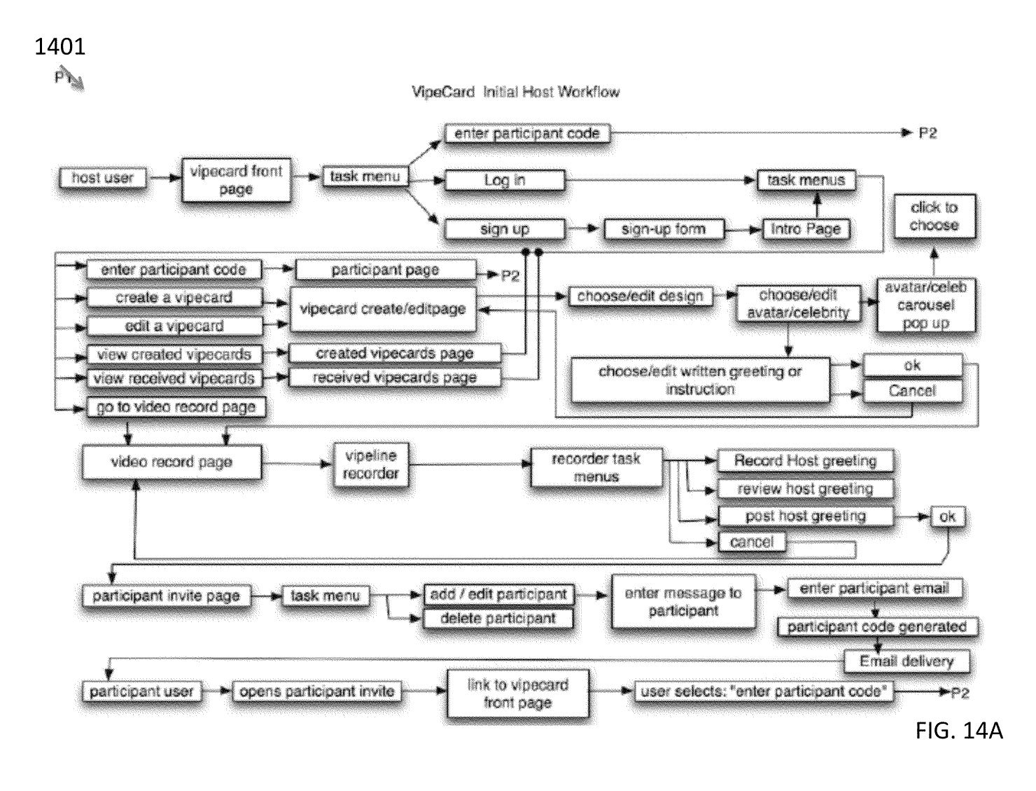

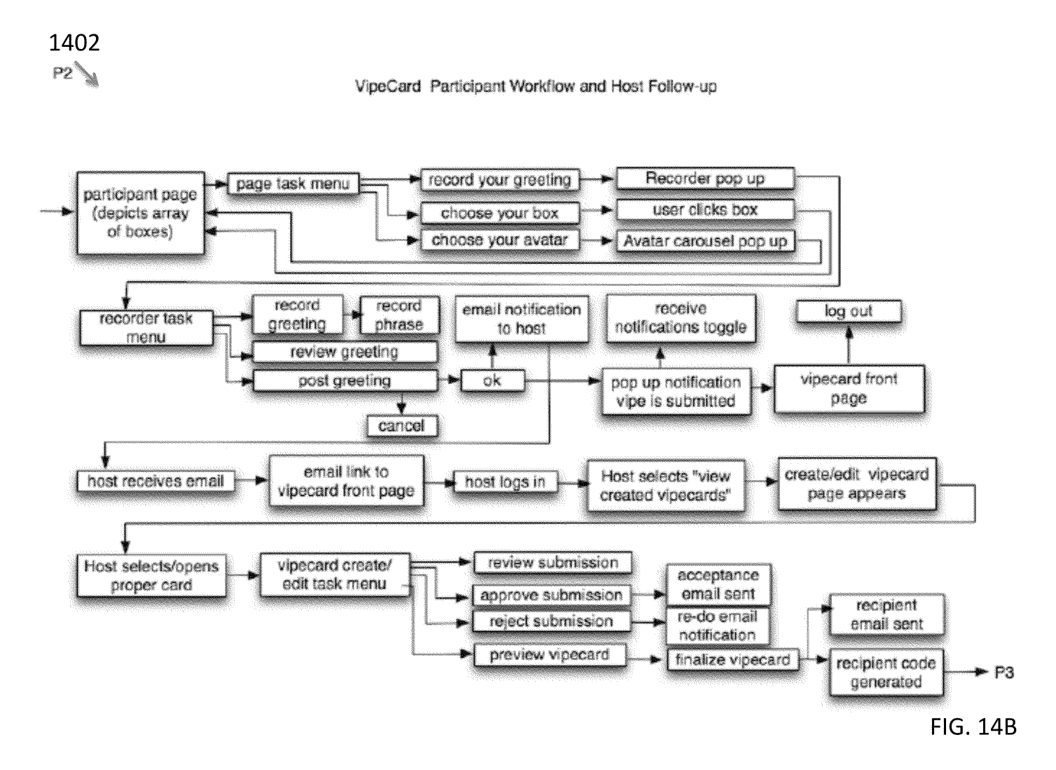

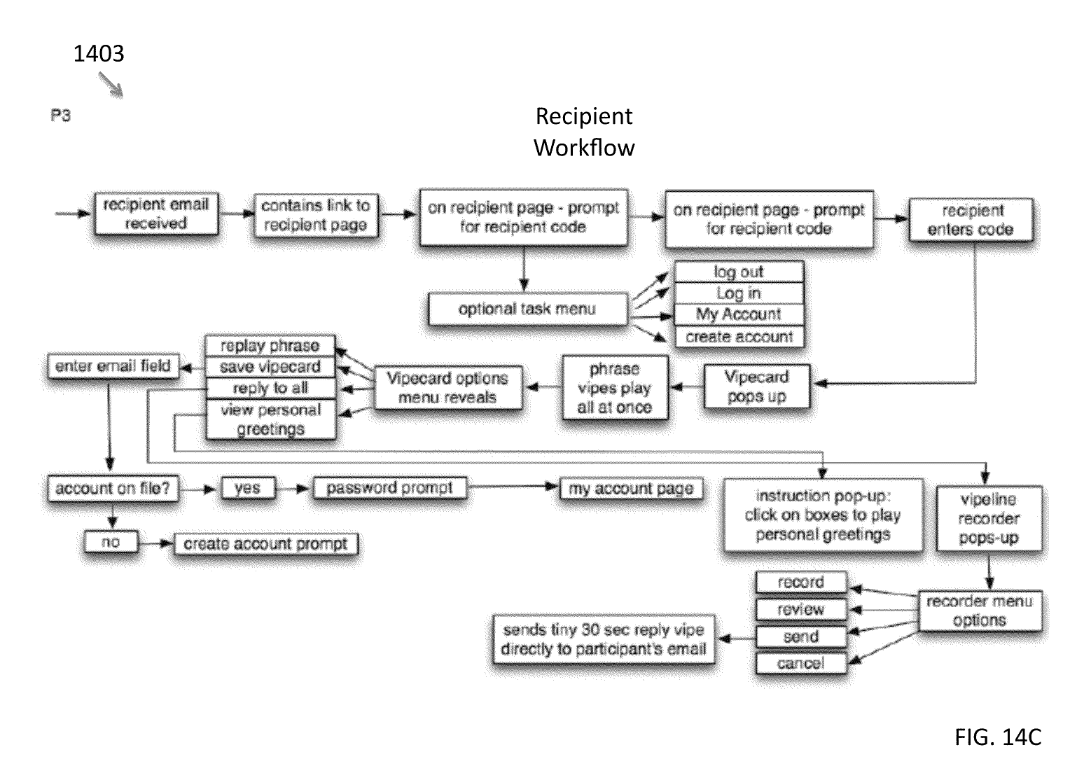

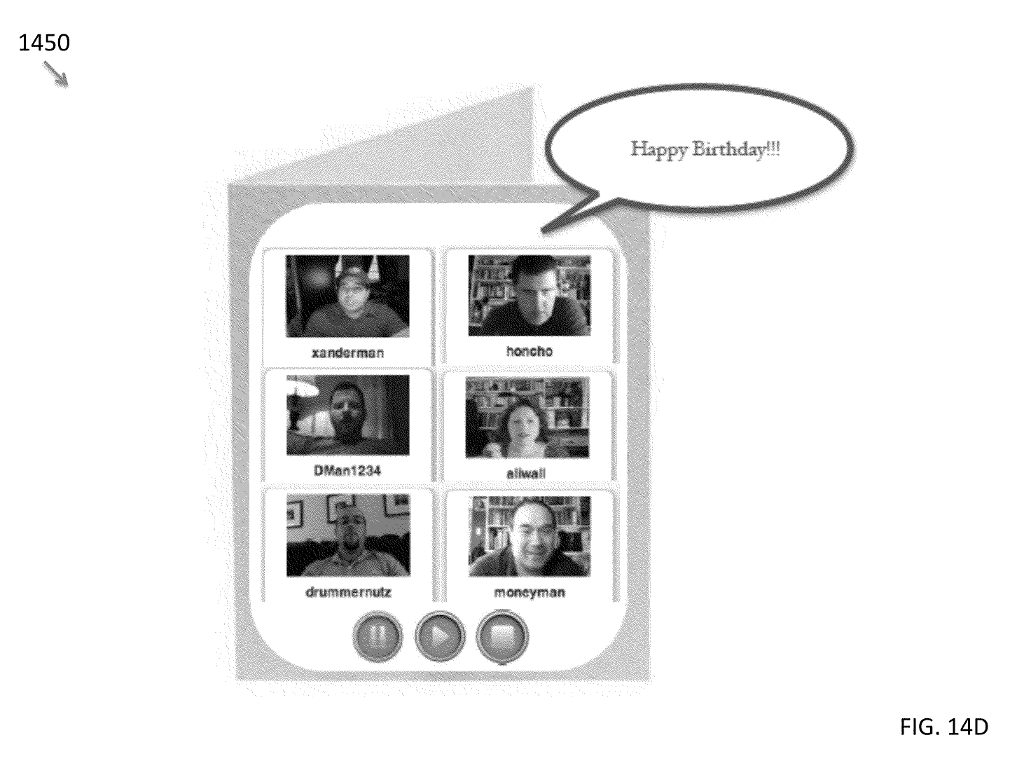

FIG. 14A illustrates an example of a host (i.e., initiator) workflow 1401 for an interactive media greeting card in accordance with exemplary embodiments. FIG. 14B illustrates an example of a participant and initiator follow-up workflow 1402 in accordance with exemplary embodiments. FIG. 14C illustrates an example of a recipient workflow 1403 in accordance with exemplary embodiments. FIG. 14D illustrates an example of an exemplary interactive media greeting card 1450.

In exemplary embodiments, the systems and methods described herein can also be implemented to generate audio/video clip albums (similar to conventional photo albums), audio/video clip yearbooks, wedding albums that can include multiple audio/video clips recorded by guests at the wedding, multi-page media album including personal audio/video clips, which can be customized as described herein.

In exemplary embodiments, the systems and methods described herein can also be implemented in public kiosks, such as convention photo booths. In this way, user can record audio/video clips in the public kiosk. In exemplary embodiments, a user can use a removable media drive (e.g., a universal serial bus (USB) drive) to download the recorded audio/video clips. Alternatively, the user can have the recorded audio/video clips emailed. As described herein, the user likely already has an account to which the newly recorded audio/video clips can be associated.

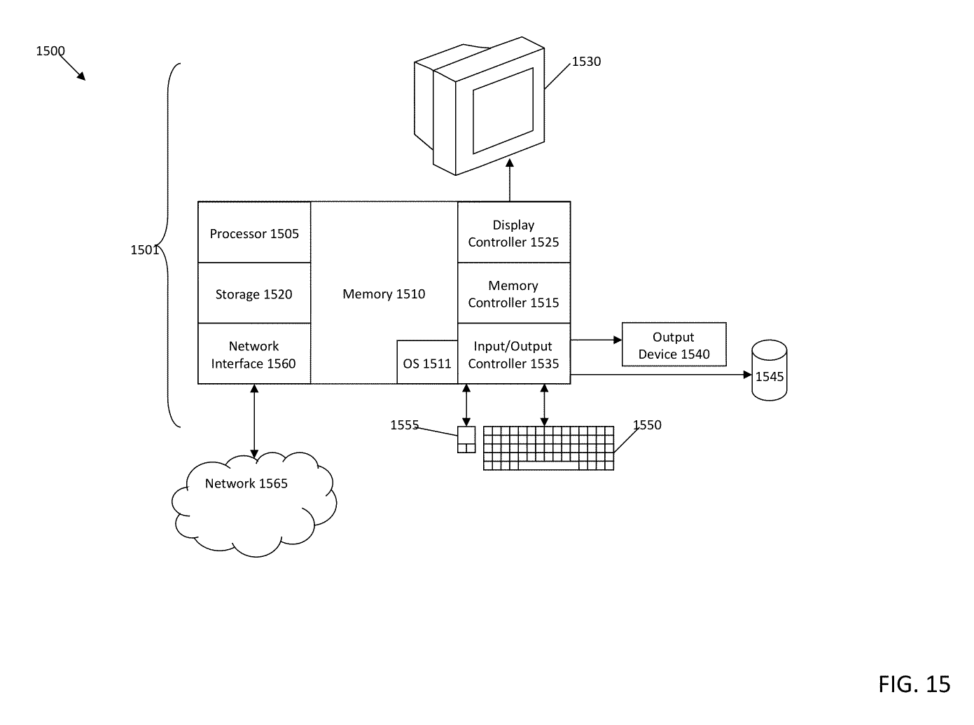

The computing systems described herein such as the client 20, 105, the server 30, 160 and the media server 40,170 can be any suitable computing system as now described. FIG. 15 illustrates an exemplary embodiment of a computing system 1500 that can be implemented for the interactive advertisement commenting methods described herein. The methods described herein can be implemented in software (e.g., firmware), hardware, or a combination thereof. In exemplary embodiments, the methods described herein are implemented in software, as an executable program, and is executed by a special or general-purpose digital computer, such as a personal computer, workstation, minicomputer, or mainframe computer. The system 1500 therefore includes general-purpose computer 1501.

In exemplary embodiments, in terms of hardware architecture, as shown in FIG. 15, the computer 1501 includes a processor 1505, memory 1510 coupled to a memory controller 1515, and one or more input and/or output (I/O) devices 1540, 1545 (or peripherals) that are communicatively coupled via a local input/output controller 1535. The input/output controller 1535 can be, but is not limited to, one or more buses or other wired or wireless connections, as is known in the art. The input/output controller 1535 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 1505 is a hardware device for executing software, particularly that stored in memory 1510. The processor 1505 can be any custom made or commercially available processor, a central processing unit (CPU), an auxiliary processor among several processors associated with the computer 1501, a semiconductor based microprocessor (in the form of a microchip or chip set), a macroprocessor, or generally any device for executing software instructions.

The memory 1510 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 1510 may incorporate electronic, magnetic, optical, and/or other types of storage media. Note that the memory 1510 can have a distributed architecture, where various components are situated remote from one another, but can be accessed by the processor 1505.

The software in memory 1510 may include one or more separate programs, each of which comprises an ordered listing of executable instructions for implementing logical functions. In the example of FIG. 15, the software in the memory 1510 includes the interactive advertisement commenting methods described herein in accordance with exemplary embodiments and a suitable operating system (OS) 1511. The OS 1511 essentially controls the execution of other computer programs, such the interactive advertisement commenting systems and methods as described herein, and provides scheduling, input-output control, file and data management, memory management, and communication control and related services.

The interactive advertisement commenting methods described herein may be in the form of a source program, executable program (object code), script, or any other entity comprising a set of instructions to be performed. When a source program, then the program needs to be translated via a compiler, assembler, interpreter, or the like, which may or may not be included within the memory 1510, so as to operate properly in connection with the OS 1511. Furthermore, the interactive advertisement commenting methods can be written as an object oriented programming language, which has classes of data and methods, or a procedure programming language, which has routines, subroutines, and/or functions.

In exemplary embodiments, a conventional keyboard 1550 and mouse 1555 can be coupled to the input/output controller 1535. Other output devices such as the I/O devices 1540, 1545 may include input devices, for example but not limited to a printer, a scanner, microphone, and the like. Finally, the I/O devices 1540, 1545 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The system 1500 can further include a display controller 1525 coupled to a display 1530. In exemplary embodiments, the system 1500 can further include a network interface 1560 for coupling to a network 1565. The network 1565 can be an IP-based network for communication between the computer 1501 and any external server, client and the like via a broadband connection. The network 1565 transmits and receives data between the computer 1501 and external systems. In exemplary embodiments, network 1565 can be a managed IP network administered by a service provider. The network 1565 may be implemented in a wireless fashion, e.g., using wireless protocols and technologies, such as WiFi, WiMax, etc. The network 1565 can also be a packet-switched network such as a local area network, wide area network, metropolitan area network, Internet network, or other similar type of network environment. The network 1565 may be a fixed wireless network, a wireless local area network (LAN), a wireless wide area network (WAN) a personal area network (PAN), a virtual private network (VPN), intranet or other suitable network system and includes equipment for receiving and transmitting signals.

If the computer 1501 is a PC, workstation, intelligent device or the like, the software in the memory 1510 may further include a basic input output system (BIOS) (omitted for simplicity). The BIOS is a set of essential software routines that initialize and test hardware at startup, start the OS 1511, and support the transfer of data among the hardware devices. The BIOS is stored in ROM so that the BIOS can be executed when the computer 1501 is activated.

When the computer 1501 is in operation, the processor 1505 is configured to execute software stored within the memory 1510, to communicate data to and from the memory 1510, and to generally control operations of the computer 1501 pursuant to the software. The interactive advertisement commenting methods described herein and the OS 1511, in whole or in part, but typically the latter, are read by the processor 1505, perhaps buffered within the processor 1505, and then executed.

When the systems and methods described herein are implemented in software, as is shown in FIG. 15, the methods can be stored on any computer readable medium, such as storage 1520, for use by or in connection with any computer related system or method.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In exemplary embodiments, where the interactive advertisement commenting methods are implemented in hardware, the interactive advertisement commenting methods described herein can implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. An interactive media commenting system, comprising:
a client computing system;
a server communicatively coupled to the client computing system;
a media server coupled to the client computing system; and
an interactive media module residing on the client computing system and configured to record and playback and interactive comment coupled to webpage provided by the server.

2. An interactive media commenting method, comprising:
receiving a web page in a computing system memory;
receiving an electronic forum in the computing system memory, the electronic forum being embedded in the web page; and
uploading a media clip into the electronic forum, the media clip being a comment related to the electronic forum.

3. An electronic card generation method, comprising:
generating a webpage having an interactive media greeting card;
generating a plurality of participant greetings within the interactive media greeting card; and
sending the interactive media greeting card to a recipient.
